(19) United States
(12) Patent Application Publication
(10) Pub. No.: US 2005/0248859 A1
(43) Pub. Date: Nov. 10, 2005

(54) Automotive outside rearview mirror system having optically similar left and right side mirrors

(76) Inventor: George E. Platzer JR., Rochester Hills, MI (US)

Correspondence Address: BROOKS KUSHMAN P.C., 1000 TOWN CENTER, TWENTY-SECOND FLOOR, SOUTHFIELD, MI, 48075, US

(21) Appl. No.: 11/116,523

(22) Filed: Apr. 28, 2005

Related U.S. Application Data
(60) Provisional application No. 60/566,053, filed on Apr. 28, 2004.

(51) Int. Cl. G02B 5/08

(52) U.S. Cl. 359/843

(57) ABSTRACT

An automotive system for determining when safe lane changes may be made is provided. The system includes an automotive outside rearview mirror for mounting on a vehicle including a main viewing section and a blindzone viewing section. The main viewing section has a viewing angle such that when the entire front end of a following vehicle in an adjacent lane is visible near the outer edge of the main viewing section, the following vehicle is at a clearance distance behind the vehicle. The blindzone viewing section has a viewing angle approximately encompassing the region between the outer limit of the viewing angle of the main viewing section and the peripheral vision line of a driver looking at the outside rearview mirror. The clearance distance is judged to be a safe separation distance for changing into the adjacent lane in front of the following vehicle.

### CROSS-REFERENCE TO RELATED APPLICATIONS

This application claims the benefit of U.S. provisional application Ser. No. 60/566,053, filed Apr. 28, 2004.

### BACKGROUND OF THE INVENTION

1. Field of the Invention

The present invention relates generally to automotive mirrors for determining safe lane change conditions.

2. Background Art

Most passenger cars today are equipped with a convex mirror on the passenger's side of the vehicle. This is done because a planar, or unit magnification mirror, of a reasonable size on the passenger's side would have a narrow and relatively useless field of view. A planar mirror on the passenger's side having the same size as the mirrors currently used on the driver's side would have a viewing angle of about half that of the driver's side mirror. This results from the fact that the passenger's side mirror is about twice the distance away from the driver's eyes as compared to the driver's side mirror. This reduction in viewing angle is unacceptable because of the large blindzone created, so a convex mirror is used to widen the viewing angle. Typically, today's driver's side mirror has a viewing angle of about 15°, and on the passenger's side convex mirror it is about 30°.

Federal Motor Vehicle Safety Standard 111 (FMVSS 111) says that if the inside mirror does not have a viewing angle of at least 20°, a planar or convex mirror must be provided on the passenger's side, and if a convex mirror is used, its radius of curvature must fall within 1651 mm and 889 mm. On the passenger's side, a 1651 mm mirror has a relative magnification of about 0.45 and the 889 mm mirror has a relative magnification of about 0.3. The relative magnification is the ratio of the image size seen in the convex mirror to the image size that would be seen in a planar mirror. With such low relative magnification, the judgment of both the distance and speed of a vehicle seen in the mirror is significantly degraded, and for most drivers the mirror is not useable for judging distance, especially in the 5 m to 20 m range, which is necessary to decide if it is safe to change lanes.

The radii of curvature specified by FMVSS 111 and the resulting viewing angles are generally able to eliminate the blindzone in the passenger's side mirror. That is, a vehicle approaching in the right adjacent lane is generally visible in that mirror continuously as the vehicle comes from infinity and until it appears in the driver's peripheral vision. This is different than the driver's side planar mirror, which has a viewing angle such that an approaching vehicle can leave the mirror's field of view before appearing in the driver's peripheral vision, thus creating a blindzone.

Today the majority of passenger car manufacturers equip their vehicles with convex mirrors on the passenger's side. By and large, the mirrors used fall within the range of 889 mm to 1651 mm. Vehicles are so equipped even if the inside mirror meets the requirements of FMVSS 111. Thus, a mirror that is relatively useless to most drivers is now commonly supplied.

### SUMMARY OF THE INVENTION

An object of this invention is to provide a passenger's side outside rearview mirror that provides the driver with the capability of unequivocally determining that a recent passed vehicle in the adjacent lane is far enough to the rear to allow the driver to move into the adjacent lane. Thus, the passenger's side mirror can be converted into a more useful mirror. Logically, drivers could use the passenger's side mirror to determine the distance of a vehicle in the adjacent lane to make a judgment on whether or not it is safe to move into that lane.

Another object of this invention is to provide the passenger's outside rearview mirror with an auxiliary mirror to display a blindzone on the passenger's side.

Yet another object of this invention is to provide a passenger's side outside rearview mirror which can display a larger image size than those currently in use.

Still another object of this invention is to provide a passenger's side mirror that is geometrically and functionally similar to a driver's side mirror.

In another embodiment of the present invention, the passenger's side outside rearview mirror comprises a main viewing convex mirror and an auxiliary convex mirror for viewing a blindzone. The main viewing convex mirror may have a first viewing angle such that the image of a front end of a trailing vehicle, in an adjacent lane, is viewable only when the trailing vehicle is at a selected safe distance behind, such as two or more car lengths. The auxiliary convex mirror may include a second viewing angle for displaying the image of objects found in the region between the outer limit of the first viewing angle and the driver's peripheral vision.

In yet another embodiment of the invention, the driver's side and passenger's side outside rearview mirrors comprise a mirror system wherein the driver's side mirror comprises a main viewing planar mirror and an auxiliary blindzone mirror that shows the driver only the blindzone on the driver's side. The passenger's side mirror comprises a main viewing convex mirror having a radius of curvature providing a viewing angle approximately equal to the viewing angle of the driver's side planar mirror. The passenger's side mirror further comprises an auxiliary convex mirror that shows the driver only the blindzone on the passenger's side. The mirror system provides the driver with left and right outside mirrors having similar useful characteristics.

### BRIEF DESCRIPTION OF THE DRAWINGS

The present invention, both as to its organization and manner of operation, together with further objects and advantages thereof, may best be understood with reference to the following description taken in conjunction with the accompanying drawing of which:

FIG. 1 is a plan view of two passenger cars on a multilane highway showing the field of view of an inside rearview mirror;

FIG. 2 is a plan view comparing the position of a vehicle seen in the inside mirror with the position of a vehicle seen in the standard passenger-side mirror;

FIG. 3 is a plan view similar to FIG. 1 illustrating the field of view of a passenger-side mirror simulating the field of view of the inside mirror;

FIG. 4 is a perspective view of an outside rearview mirror according to an aspect of the present invention; and

FIG. 5 is a plan view of a passenger car on a multilane highway, wherein the car has left and right outside rearview mirrors with geometrically similar fields of view, illustrating the various fields of view of the mirrors.

### DETAILED DESCRIPTION OF THE PREFERRED EMBODIMENT(S)

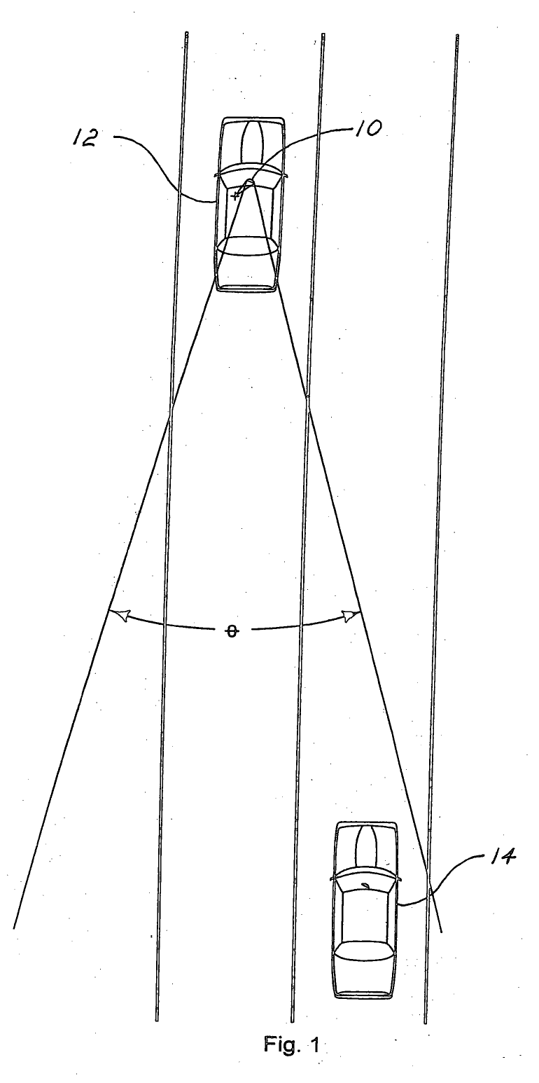

FIG. 1 shows the field of view, θ, of an inside rearview mirror 10 on a leading passenger car 12 and a trailing passenger car 14 whose front end is entirely visible in mirror 10. Most passenger cars today have a wide enough rear window and a wide enough inside rearview mirror to provide a total viewing angle of about 30° or 15° right and left. This characteristic of the inside rearview mirror has led to a widely used and very safe procedure for determining when it is safe to change lanes to the adjacent lane after having passed a vehicle in that lane. The National Safety Council (NSC) instructs its students in their Defensive Driving Training Course as follows:
“It is safe to return to your lane only when you see the entire front of the vehicle you are passing in your inside rearview mirror. Before you actually move into the lane, check your right blind spot. Move smoothly into the right lane when it is safe.”

This is the procedure still taught today. Use of the convex passenger's side outside rearview mirror is not included in the instructions. The relative magnification of the convex passenger's side mirror is too low to recommend its use for determining the position of the passed vehicle by most drivers. A few drivers may become skilled enough to judge the distance of a vehicle in the range of 3 m to 10 m behind their vehicles, but the average driver cannot do this with sufficient accuracy for safe lane changing.

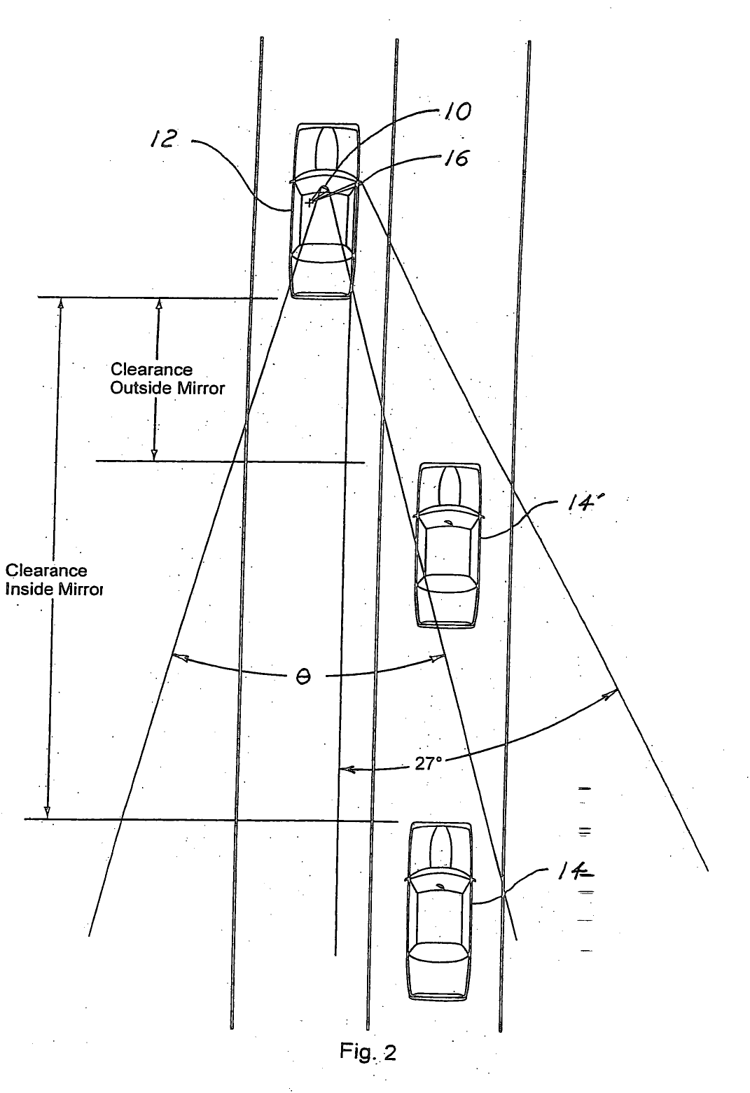

FIG. 2 illustrates how the NSC rule, requiring that the entire front of a vehicle in the adjacent lane be visible before changing lanes, does not work with a standard passenger's side outside mirror. As an illustrative example, a standard passenger's side mirror 16 with a radius of curvature of 1016 mm having a viewing angle of 27 degrees is shown. Using the inside rearview mirror 10 having a viewing angle of approximately 15 degrees to the right of center (θ/2˜15°), the NSC rule provides over three car lengths of clearance to the trailing passenger car 14. However, using the standard passenger's side mirror 16, the clearance between cars drops to about one car length as shown by trailing passenger car 14′. While aggressive drivers may use a one-car length clearance, it is not good practice. Moreover, if cargo or passengers block the view from the rear window, the NSC procedure cannot be effectively used. Thus, it is desirable to provide a passenger's side outside mirror having the same viewing angle as the inside rearview mirror, which can be used in the same manner to determine when it is safe to move into the adjacent lane.

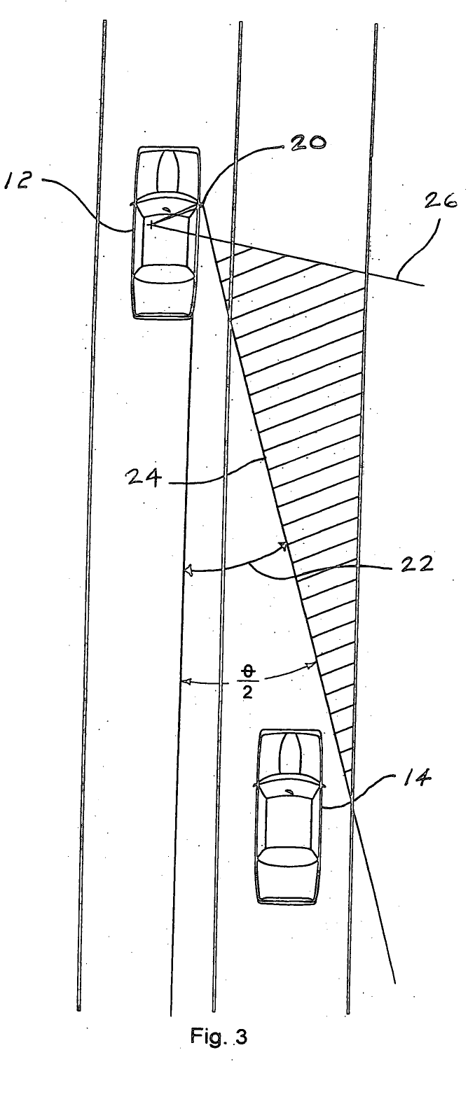

Referring now to FIG. 3, a passenger's side rearview mirror 10 in accordance with an aspect of the present invention is shown. The passenger's side mirror 20 can have a main viewing angle 22 approximately equal to θ/2. Consequently, the trailing passenger car 14 can again be positioned several car lengths behind leading passenger car 12 when its front end is completely visible in passenger's side mirror 20. In a certain embodiment, the passenger's side mirror 20 can be spherically convex. In a certain vehicle, for example, the main viewing angle 22 of mirror 20 can be approximately θ/2 if its radius of curvature is about 3000 mm. Of course, the radius of curvature is vehicle dependent and a viewing angle of θ/2 can be achieved by various other radii of curvature. For example, in another test vehicle, a viewing angle of θ/2 was achieved using a radius of curvature of 3800 mm. By this simple expedient, the passenger's side mirror 20 can be converted to a highly useful mirror. However, making the main viewing angle 22 of passenger's side mirror 20 approximately θ/2 can create a blindzone region, shown crosshatched in FIG. 3, which is defined as the region bounded by the outer limit line 24 of the main viewing angle 22 and the driver's peripheral vision line 26. U.S. Pat. No. 6,315,419 assigned to G. E. Platzer, and hereby incorporated by reference, explains how to treat this blindzone region.

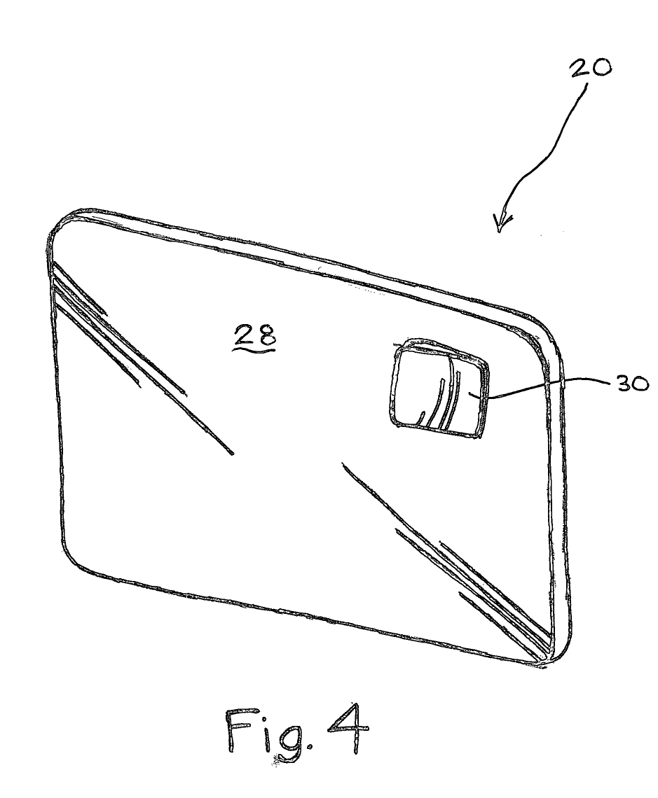

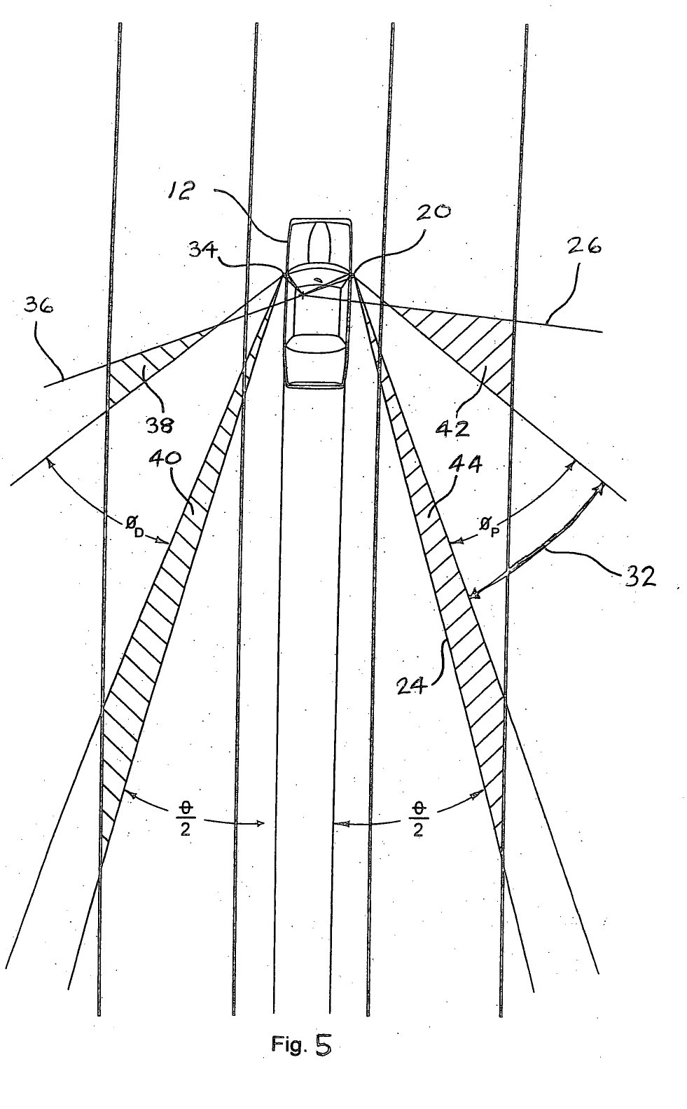

In the above referenced patent, many embodiments of a blindzone mirror are shown, all of which are applicable to passenger's side mirror 20. Referring to FIG. 4, the passenger side mirror 20 is illustrated in greater detail. In one embodiment of the present invention, passenger side mirror 20 may include a main viewing section 28 and a blindzone viewing section 30. The main viewing angle 22 can correspond to the main viewing section 28. Similarly, the blindzone viewing section 30 may have a blindzone viewing angle 32, shown in FIG. 5. The blindzone viewing section 30 can be a spherically convex mirror designed to display the blindzone only. Thus, all extraneous visual information is removed so that when a vehicle is viewed in the blindzone viewing section, there is little doubt that a vehicle is indeed in the blindzone. Further, the image of a vehicle in the blindzone viewing section can be large enough to nearly fill the blindzone viewing section's area, making the presence of a vehicle in the blind zone unmistakable. By locating the blindzone viewing section 30 in the upper and outer quadrant of passenger's side mirror 20, the entire mirror complies with FMVSS 111.

FIG. 5 depicts the fields of view of a driver's side mirror 34 and the passenger's side mirror 20 according to an aspect of this invention. The field of view of passenger's side mirror 20 can include the main viewing angle 22 of the main viewing section 28 denoted by θ/2 and the blindzone viewing angle 32 of the blindzone viewing section 30 denoted by Φ_{P}. Driver's side mirror 34 can be similar to passenger's side mirror 20 having a field of view of θ/2, corresponding to a planar section, and Φ_{D} corresponding to a blindzone section. Line 36 is the driver's peripheral vision limit when looking at driver's side mirror 34. Both Φ_{D} and Φ_{P} can have values in the range of 30′ depending upon the optical characteristics of the blindzone viewing sections. These values can vary based upon the specific vehicle and the design goals. Viewing angles Φ_{D} and Φ_{P} can provide a field of view in the original blindzones such that the remaining slivers 38, 40, 42, and 44, shown cross-hatched, are unable to hide a vehicle. Thus, a system of left and right outside mirrors having similar characteristics may be provided which clearly tells a driver if there is a vehicle in the left or right blindzone, and also clearly informs a driver if a recently passed vehicle in the adjacent lane is far enough back to allow a safe movement to the adjacent lane. The uncertainty of the position of a vehicle in the adjacent lane resulting from the low relative magnification of the typical convex passenger mirrors is eliminated. The system is easy to use and there are no longer any difficult decisions to be made about a vehicle in the adjacent lane. That is, either vehicle is in the blindzone or it is several car lengths behind.

A similar system could be used employing aspheric mirrors instead of a planar mirror and a constant radius curvature blindzone mirror on the driver's side.

While embodiments of the invention have been illustrated and described, it is not intended that these embodiments illustrate and describe all possible forms of the invention. Rather, the words used in the specification are words of description rather than limitation, and it is understood that various changes may be made without departing from the spirit and scope of the invention.

1. An automotive outside rearview mirror for mounting on a vehicle, said outside rearview mirror comprising:
a main viewing section having a main viewing angle for displaying the image of a front end of a trailing vehicle in an adjacent lane at an outer edge of the main viewing section when the trailing vehicle is at a clearance distance of greater than one car length behind the leading vehicle, where the clearance distance is the distance between a rear bumper of the leading vehicle and a front bumper of the trailing vehicle; and
a blindzone viewing section having a blindzone viewing angle approximately encompassing the region between the outer limit of the main viewing angle of the main viewing section and the peripheral vision line of a driver looking at the outside rearview mirror;
wherein the clearance distance is judged to be a safe separation distance for changing into the adjacent lane in front of the trailing vehicle provided that another vehicle is not visible in the blindzone viewing section and that the image of the trailing vehicle in the main viewing section is not increasing in size.

2. The outside rearview mirror according to claim 1, wherein the outside rearview mirror is a passenger's side mirror.

3. The outside rearview mirror according to claim 2, wherein the main viewing section and the blindzone viewing section are spherically convex.

4. The outside rearview mirror according to claim 2, wherein the main viewing section is spherically convex and the blindzone viewing section is aspheric.

5. The outside rearview mirror according to claim 1, wherein the outside rearview mirror is a driver's side mirror.

6. The outside rearview mirror according to claim 5, wherein the main viewing section is planar and the blindzone viewing section is spherically convex.

7. The outside rearview mirror according to claim 5, wherein the main viewing section is spherically convex and the blindzone viewing section is aspheric.

8. The automotive outside rearview mirror according to claim 1, wherein the selected clearance distance is between 20 m and 15 m.

9. The automotive outside rearview mirror according to claim 1, wherein the selected clearance distance is between 15 m and 10 m.

10. The automotive outside mirror according to claim 1, wherein the main viewing section has a radius of curvature between 2500 mm and 3000 mm.

11. The automotive outside mirror according to claim 1, wherein the main viewing section has a radius of curvature between 3000 mm and 4000 mm.

12. A system for determining safe lane change conditions for a vehicle, the system comprising:
a right-side outside rearview mirror including a first main viewing section and a first blindzone viewing section, the first main viewing section having a first main viewing angle for displaying the image of a front end of a trailing vehicle in a right adjacent lane at an outer edge of the first main viewing section when the trailing vehicle is at a clearance distance of greater than one car length behind the vehicle, the first blindzone viewing section having a first blindzone viewing angle approximately encompassing the region between the outer limit of the first main viewing angle of the first main viewing section and the peripheral vision line of a driver looking at the right-side outside rearview mirror; and
a left-side outside rearview mirror including a second main viewing section and a second blindzone viewing section, the second main viewing section having a second main viewing angle for displaying the image of a front end of a trailing vehicle in a left adjacent lane at an outer edge of the second main viewing section when a following vehicle is at a clearance distance of greater than one car length behind the vehicle, the second blindzone viewing section having a second blindzone viewing angle approximately encompassing the region between the outer limit of the second main viewing angle of the second main viewing section and the peripheral vision line of a driver looking at the left-side outside rearview mirror
wherein the clearance distance is the distance between a rear bumper of the vehicle and a front bumper of the trailing vehicle and wherein each of the main viewing angles yield approximately the same clearance distance.
